(19) United States
(12) Patent Application Publication
(10) Pub. No.: US 2013/0120568 A1
(43) Pub. Date: May 16, 2013

(54) Security and Marketing System

(71) Applicant: Michael E. Jensen, II, Ottawa, KS (US)

(72) Inventor: Michael E. Jensen, II, Ottawa, KS (US)

(21) Appl. No.: 13/296,442

(22) Filed: Nov. 15, 2011

(51) Int. Cl. H04N 7/18

(52) U.S. Cl. 348/143; 348/E07.085

(57) ABSTRACT

A security and marketing system according to the present invention includes a processor configured to execute programming instructions and a memory in data communication with the processor. The memory is configured to store the programming instructions for execution by the processor and digital content. A display device is in data communication with the processor and configured to display the digital content according to the programming instructions. The display device includes a generally transparent view portal. The system includes a video camera adjacent the display device and adjacent the view portal, the video camera being directed to record an area forward of the display device.

### BACKGROUND OF THE INVENTION

This invention relates generally to computer information systems and, more particularly, to a display medium configured to selectively inform or interact with people while video recording the immediate environment surrounding the display medium.

Video display screens are becoming more common in places of business such as retail stores, restaurants, doctor's offices, and the like and provide a means for the business to inform customers regarding products, services, physical wellness, or other topics of interest. For example, interactive touch screen video systems are being provided in restaurants to selectively display advertisements and to enable patrons to enter their food and drink orders.

Security and surveillance cameras are also commonly encountered in business and government facilities. Security cameras are typically situated at elevated positions in order to record wide areas and to avoid tampering by unauthorized persons. One purpose of obvious placement of security cameras is to overtly deter criminal behavior. In other words, a criminal is less likely to commit a crime, such as vandalism or theft, if he believes he is being watched or recorded. Unfortunately, the overt placement of cameras may work to a criminal's advantage in that he may be able to strategically conduct a criminal activity in an area where no camera is positioned.

Various devices have been proposed in the art for providing security cameras including covert camera housings and mounts. Although presumably effective for their intended purposes, the existing devices can not be strategically located in close proximity to where criminal activity needs to be monitored without being noticed by a perpetrator, such as on the wall of an elevator, in a business lobby, or other open forums that may typically include an information screen, kiosk, or station.

Therefore, it would be desirable to have a security and marketing system in which a display device capable of displaying digital content that also includes a security recording apparatus. Further, it would be desirable to have a security and marketing system in which the display device is interactive with a user. In addition, it would be desirable to have a security and marketing system in which a security camera is hidden.

### SUMMARY OF THE INVENTION

A security and marketing system according to the present invention includes a processor configured to execute programming instructions and a memory in data communication with the processor. The memory is configured to store the programming instructions for execution by the processor and digital content. A display device is in data communication with the processor and configured to display the digital content according to the programming instructions. The display device includes a generally transparent view portal. The system includes a video camera adjacent the display device and adjacent the view portal, the video camera being directed to record an area forward of the display device.

Therefore, a general object of this invention is to provide a security and marketing system that provides a marketing display medium and covert security system.

Another object of this invention is to provide a security and marketing system, as aforesaid, in which the display medium is interactive with spectators.

Still another object of this invention is to provide a security and marketing system, as aforesaid, in which the security system includes a video camera that is hidden from view.

Yet another object of this invention is to provide a security and marketing system, as aforesaid, that may be mounted on a wall, positioned on a counter/shelf, even situated in an automobile such as a taxi cab.

A further object of this invention is to provide a security and marketing system, as aforesaid, that may be mounted in close proximity to the area desired to be recorded.

A still further object of this invention is to provide a security and marketing system, as aforesaid, in which new digital content may be uploaded to the system for interactive display.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a security and marketing system according to one embodiment of the present invention and installed in an elevator;

FIG. 2 is a rear perspective view of the system as in FIG. 1 with a video camera housing installed;

FIG. 3 is another rear perspective view of the system as in FIG. 1 with the video camera housing removed to reveal the video camera;

FIG. 4 is a rear perspective view of another embodiment of the system in which the camera housing and camera are covertly coupled to the rear of a camera mounting member;

FIG. 5 is a front view of the system as in FIG. 4;

FIG. 6 is a perspective view of the system as in FIG. 1;

FIG. 7 is a back view of the system as in FIG. 3;

FIG. 8a is a perspective view of the camera housing as in FIG. 2;

FIG. 8b is a front view of the camera housing as in FIG. 8a;

FIG. 8c is a rear view of the camera housing as in FIG. 8a;

FIG. 9 is a rear perspective view of a security and marketing system according to another embodiment of the present invention;

FIG. 10 is a front perspective view of the system as in FIG. 9;

FIG. 11 is a rear perspective view of a display device as in FIG. 9 with the video camera removed;

FIG. 12 is a front perspective view of the video camera as in FIG. 9;

FIG. 13 is a rear perspective view of the video camera as in FIG. 9;

FIG. 14 is a block diagram of the system as in FIGS. 1 and 9; and

FIG. 15 is a flowchart illustrating the logic of the processor according to the present invention.

### DESCRIPTION OF THE PREFERRED EMBODIMENT

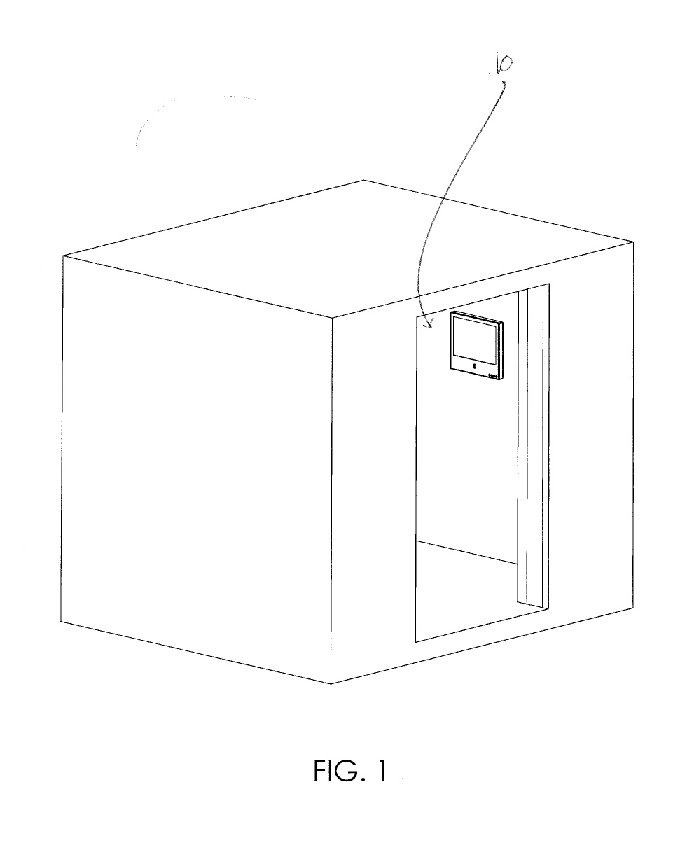

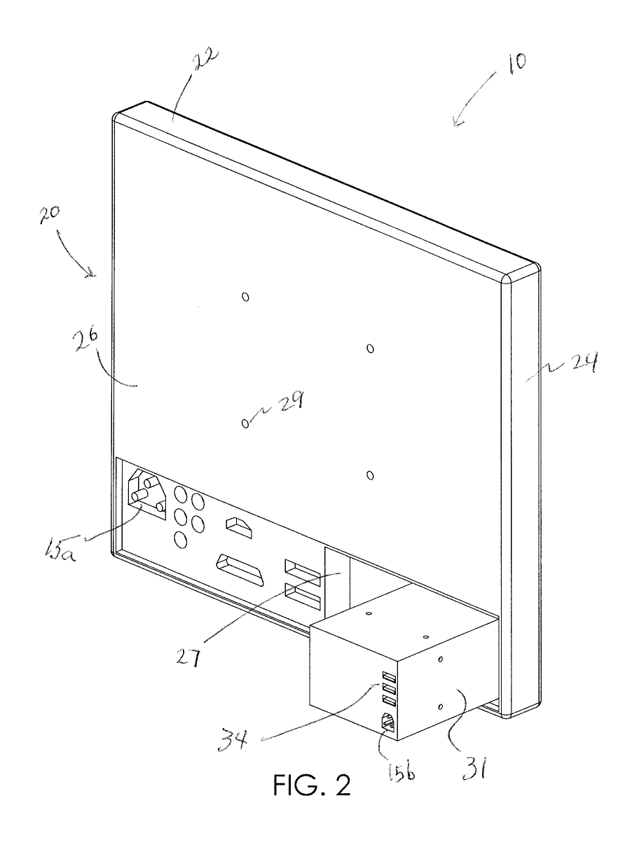

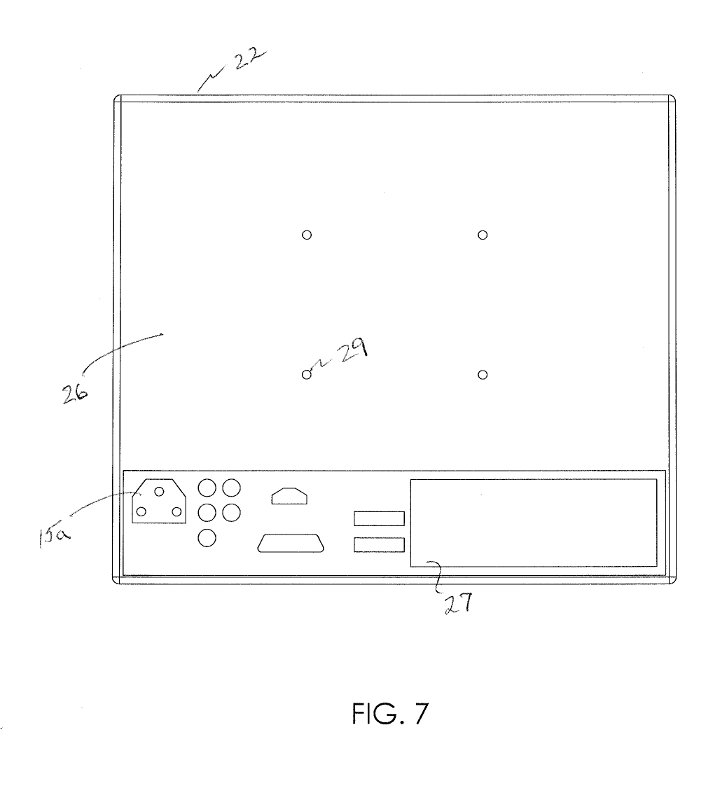

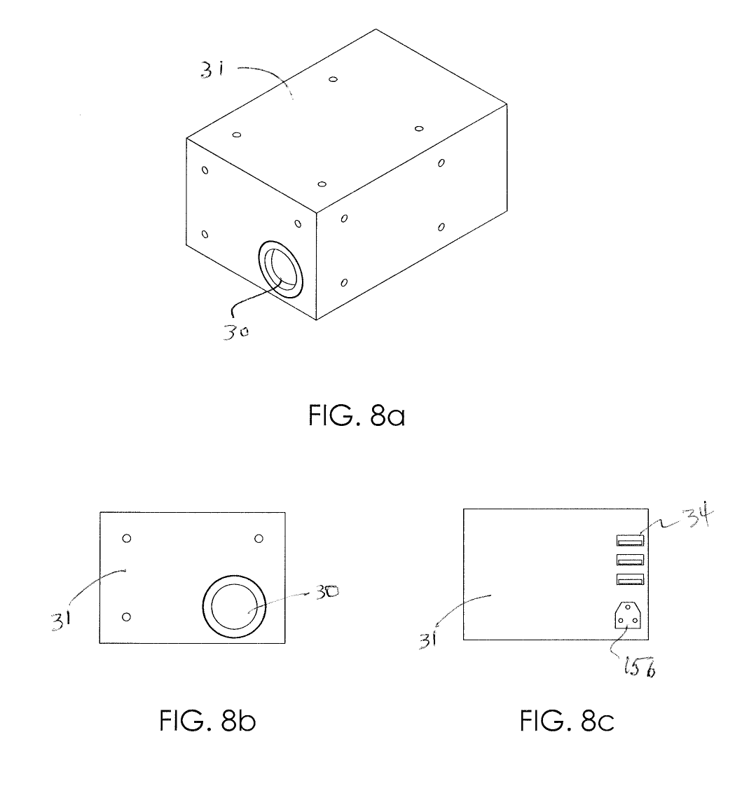

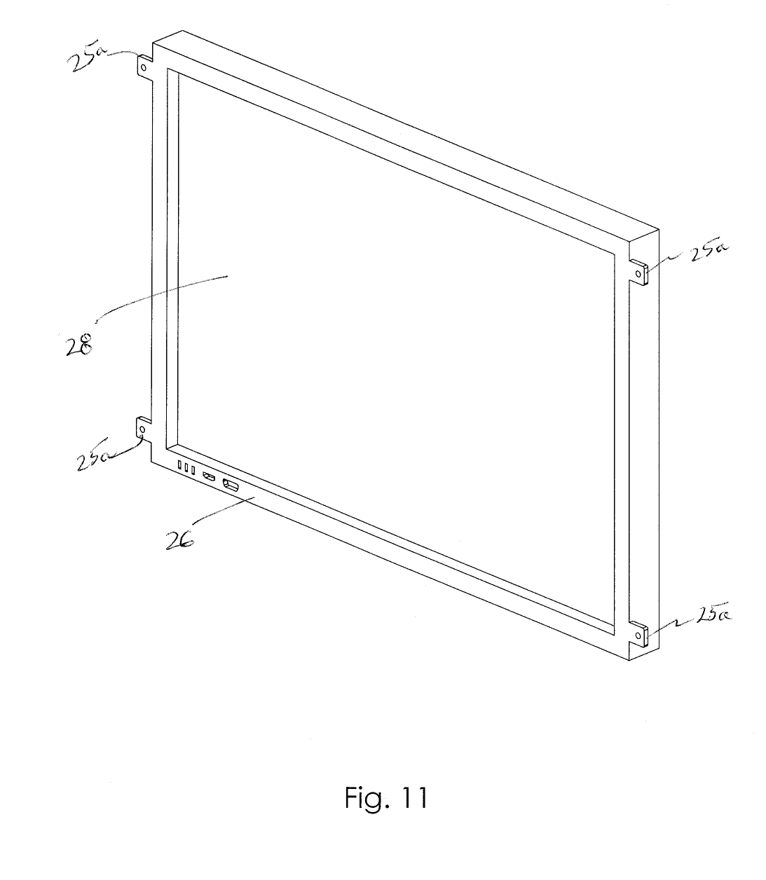

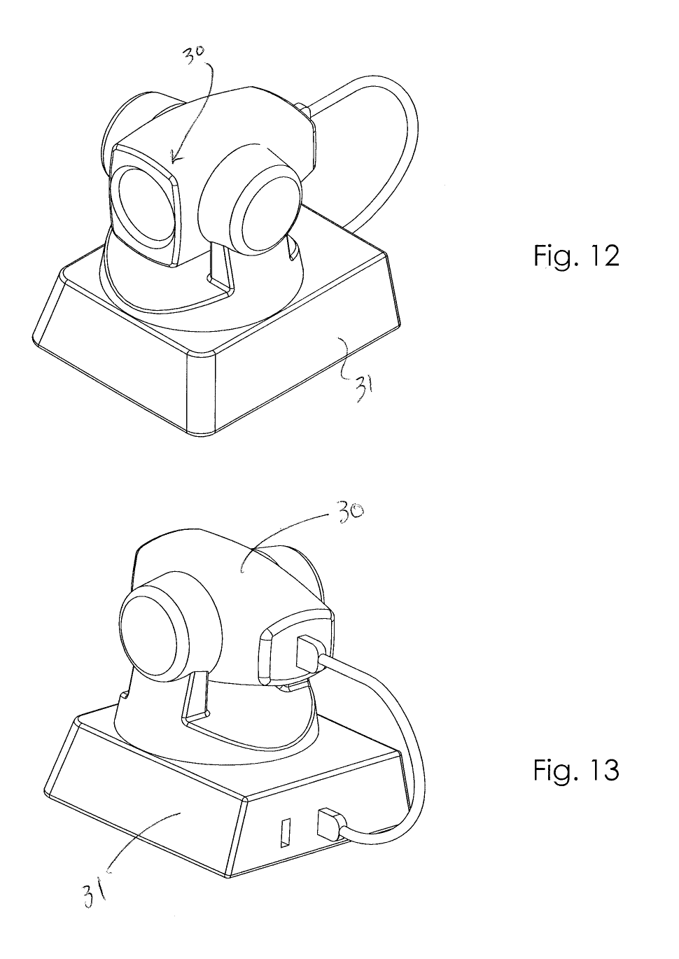

A security and marketing system according to a preferred embodiment of the present invention will now be described with reference to FIGS. 1 to 14 of the accompanying drawings. The security and marketing system 10 includes a display device 20, a video camera 30 positioned behind the display device 20, a processor 12, and a memory 14 in data communication with the processor 12 and video camera 30 that is configured to store digital content, programming instructions and recorded data. The processor 12 is configured to execute programming instructions. As will be seen in the drawings, the electronics, including the processor 12, memory, and video camera 30 may be contained in a camera housing 31 (FIG. 2). The camera housing 15b may include a power receptacle 15b by which internal electronics may be energized.

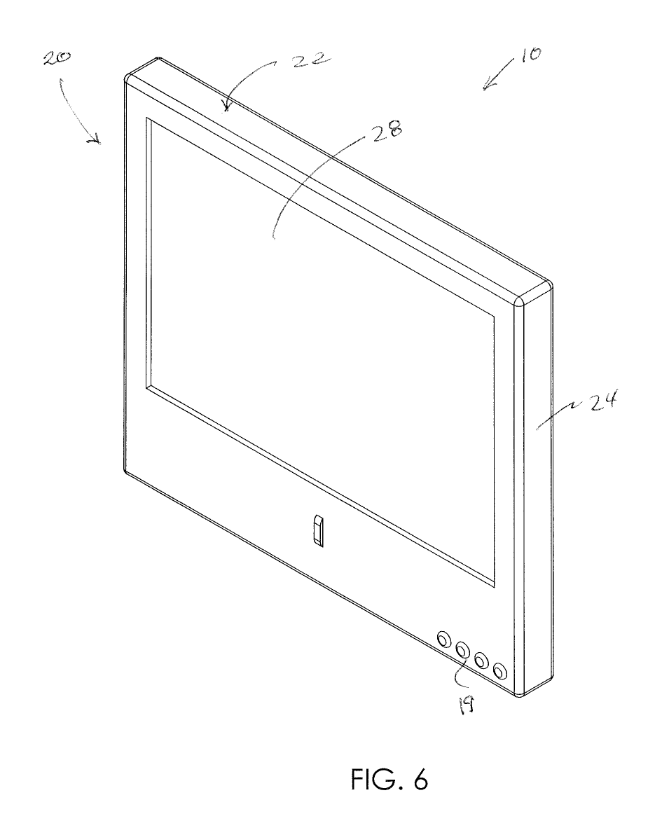

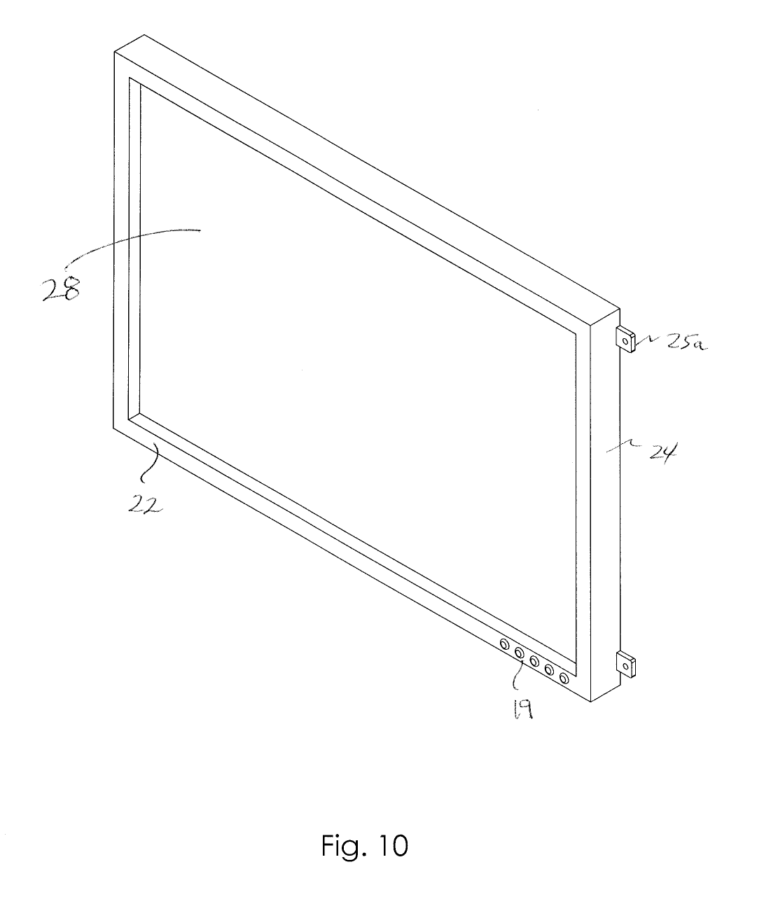

The display device 20 is configured to display digital data from the memory 14 according to programming instructions executed by the processor 12. It is understood that the digital data stored in memory 14 and displayed by the display device 20 may be still pictures, video, and/or interactive text or graphics. The display device 20 may include a framework 22 and a display screen 28 mounted within the framework 22. In some embodiments, the display screen 28 may comprise the majority of the area defined by the framework 22 (FIGS. 10). In other embodiments, however, the display screen 28 may comprise less of that area for reasons that will be explained more fully later (FIG. 6). The display device 20 includes a power connector/plug 15a and traditional input buttons 19.

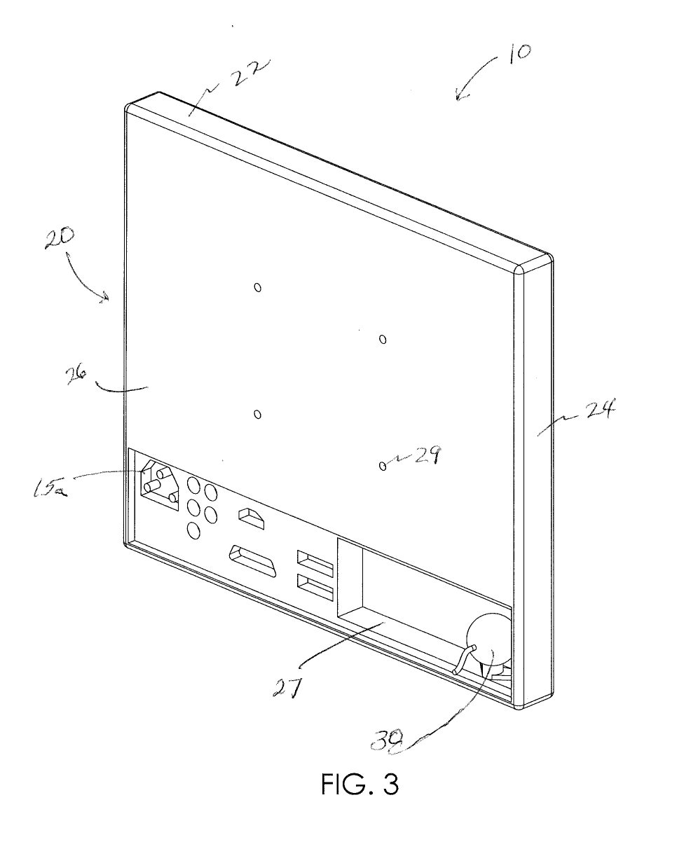

Preferably, the video camera 30 is positioned rearwardly adjacent the display device 20 and directed to record an area forward of the front of the display device 20 (FIG. 3). More particularly, the display device 20 defines a generally transparent view portal through which the lens of the camera 30 has an obstructed view of an area forward of the display device 20. In some embodiments, a back side 26 of the display device framework 22 may define a recessed area 27 that is configured to receive the video camera 30 (FIGS. 2 and 3). A front side of the framework 22 may include a tinted transparent window aligned with the recessed area 27 through which the video camera 30 is capable of recording an area forward of the display device 20. Preferably, substantially all of the framework is constructed of black plastic so that the tinted window is not apparent. In this embodiment the tinted and transparent panel constitutes the view panel. Further, this embodiment may be mounted to a wall using the back wall fasteners 29.

Video data recorded by the video camera 30 may be stored in the memory 14 according to respective programming instructions. It is understood that new video data may override previously stored data based on a predetermined size of stored data or after a predetermined amount of time. It should also be appreciated that the video camera 30 may be manually directionally adjusted by an administrator or be programmed to pan from side to side, zoom in and out, etc. as controlled by software.

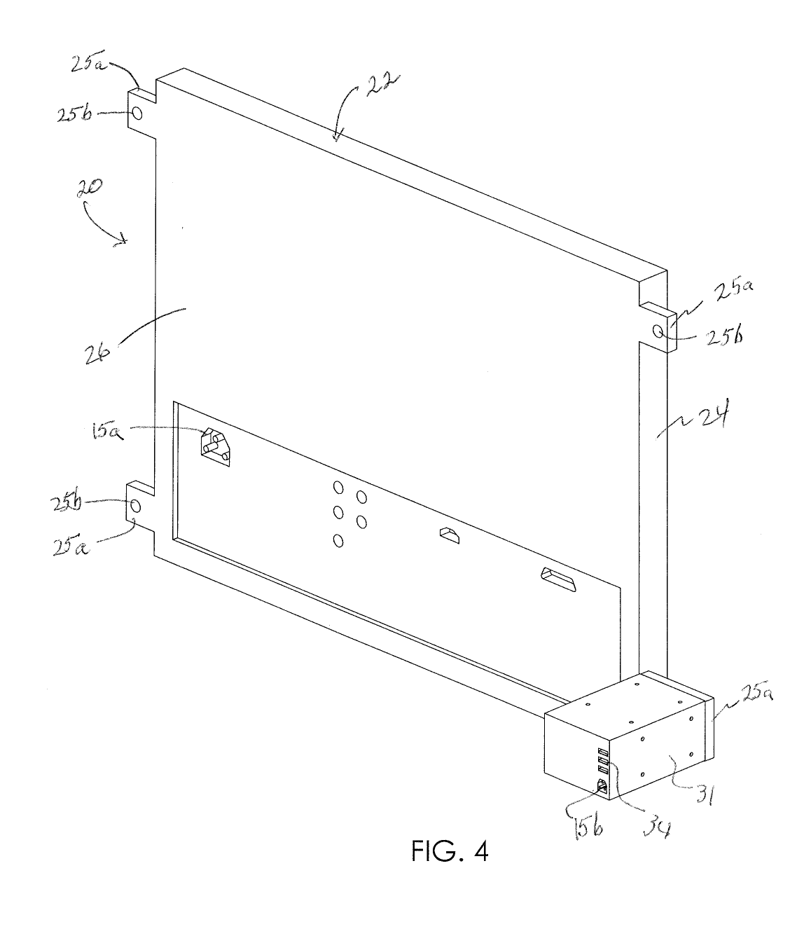

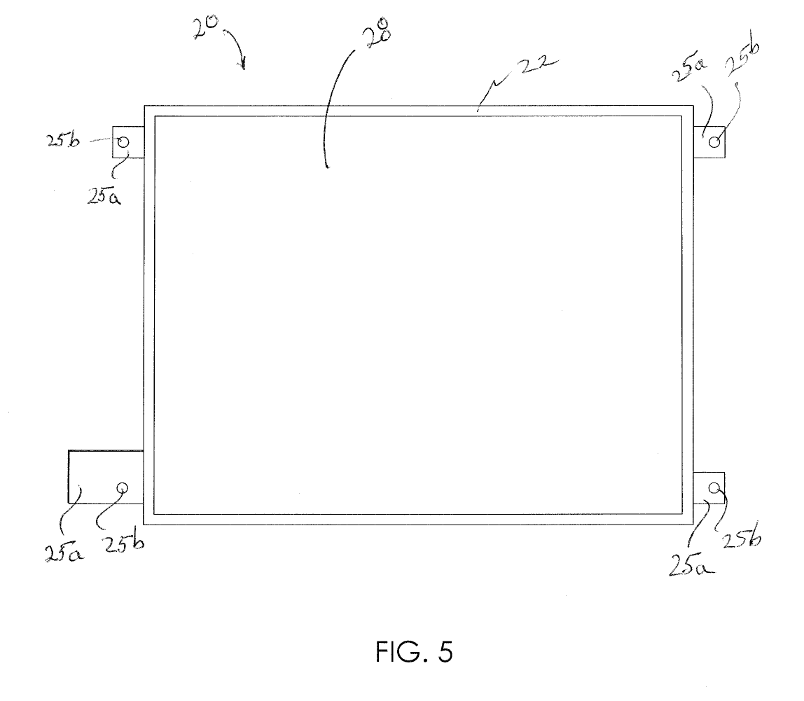

In other embodiments, the video camera 30 may be covertly positioned behind a display device wall mounting member. More particularly, the display device 20 may include at least one wall mounting member 25a extending outwardly from the framework 22, such as from a respective peripheral side 24. Each mounting member 25a may define an aperture 25b for receipt of a fastener (FIG. 4). However, the aperture 25b may also serve as the view portal when the video camera 30 is positioned to the rear of a respective mounting member 25a as shown in FIGS. 4 and 5. In other words, the video camera 30 may be covertly positioned behind a mounting member 25a and, thereby, record video of the area forward of the display device 20. The system 10 of course, may be positioned on a counter or table surface rather than mounted on a wall.

In still other embodiments, the display screen 28 may be generally transparent when digital data is not being actively displayed thereon. It is understood that in this embodiment, the display screen 28 may substantially cover the entire display device framework 22.

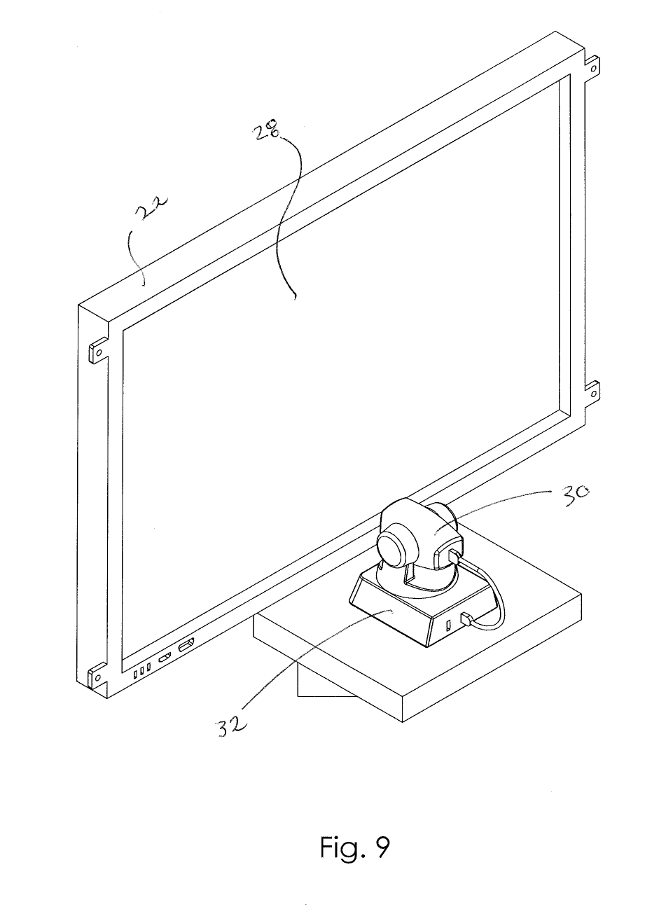

Accordingly, the video camera 30 may be positioned adjacent a rear side of the display screen 28 and be directed forwardly so as to record the area forward of the display device 20 (FIG. 9). In this embodiment, the video camera 30 may include an auxiliary housing 32 configured to contain other electronic components. It is understood that the view portal in this embodiment is the transparent display screen that hides the video camera when digital data is displayed and which enables the video camera 30 to record the area in front of the display screen 28.

In another aspect of the invention, the display device 20 may be a touch screen display. Specifically, the display device 20 includes a screen that is itself an input device enabling a user to supply input to the processor 12 by touching the screen. Having a touch screen display enables active digital content to be used with the present system as is common with information systems, restaurant ordering systems, and various entertainment systems. The touch screen allows user input to be collected and communicated to the processor 12., the processor, under programming control, causing the digital data to be changed, modified, or supplied based on the input. Accordingly, the combination of a touch screen display device that is programmed to display audio and visual content and a hidden video camera provides an effective security and marketing system.

The security and marketing system 10 may include a USB port 34 in data communication with the processor 12 and memory 14. The USB port 34 enables a user, such as a system administrator to upload new digital content to be displayed by the display device 20. For example, new data may be uploaded from a jump drive into the memory 14. In addition, the USB port 34 may enable stored video recordings to be downloaded from memory 14 to an external hard disk drive, to a laptop computer, or the like.

The security and marketing system 10 may include other means for communicating video recording data away from the system and for downloading additional digital content to be displayed. More particularly, the security and marketing system 10 may include a transmitter 16 in data communication with the processor 12 (FIG. 13). There is programming that when executed may cause the transmitter 16 to transmit recorded data that is stored in the memory 14. Recorded data may be transmitted to a remote security station 17, to an administrator's cell phone, or the like. In addition, the system 10 may also include means for connecting the processor 12 and memory 14 to the internet for communicating data to and from a remote computer or monitoring station 17.

In addition, the security and marketing system 10 may include a receiver 18 in data communication with the processor 12 (FIG. 13). There is programming that when executed may cause the receiver 18 to wirelessly receive new or additional digital content to later be displayed on the display device 20 as described previously. Therefore, an administrator may update the digital data to reflect new advertising information, new company data, new entertainment and interactive data, or anything desired to be displayed.

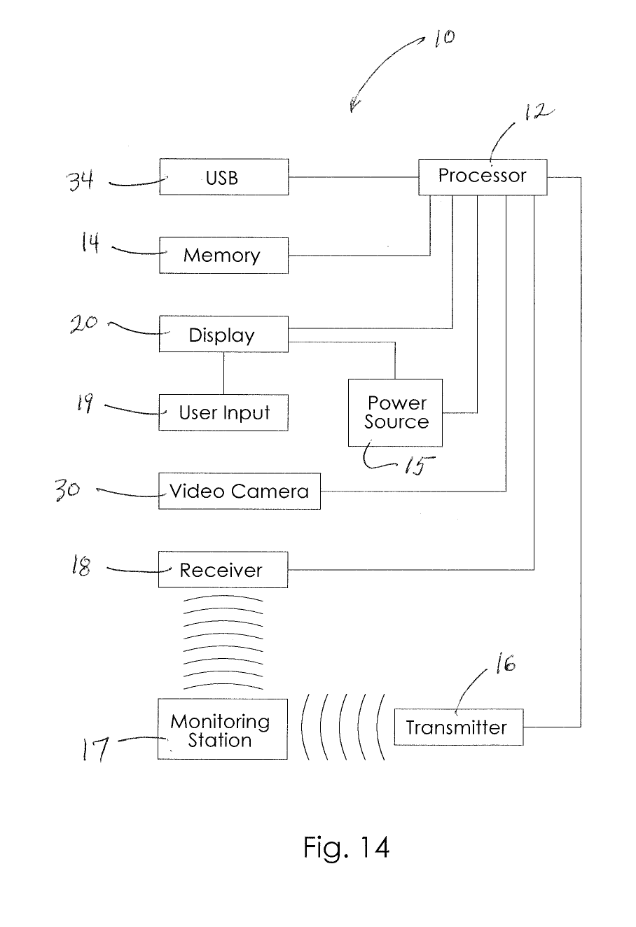

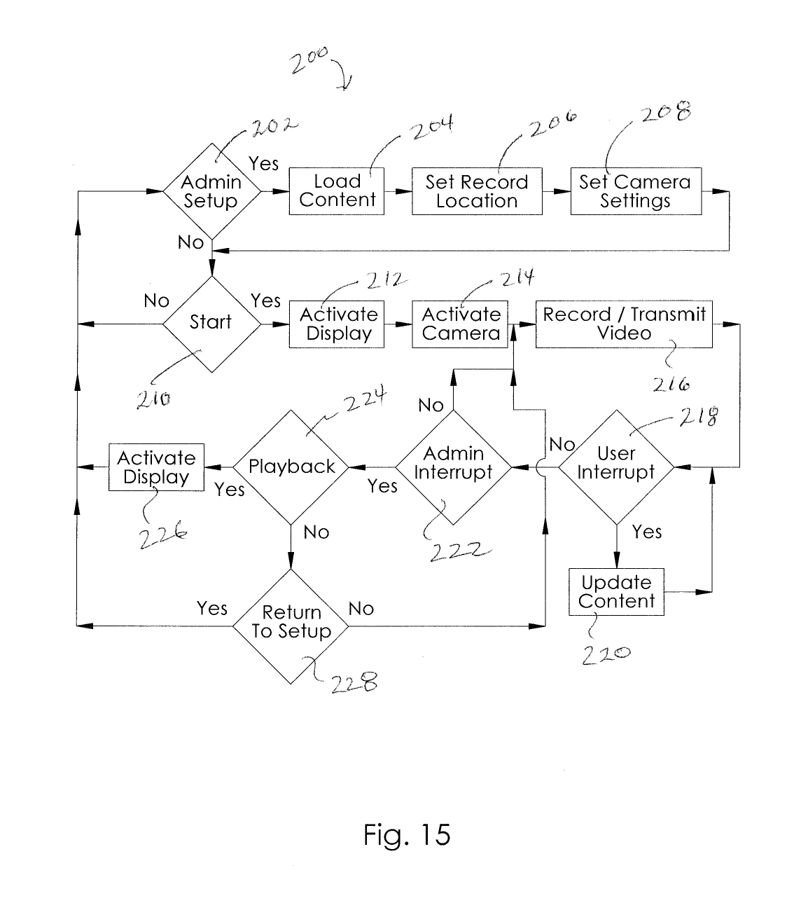

A methodology of using the security and marketing system 10 is illustrated by way of the flowchart shown in FIG. 14. It is understood that the methodology of the present system may be programming instructions executed by the processor 12. Specifically, the processor 12 may execute a process 200 as explained below. At step 202, the processor 12 determines if an administrative setup procedure is desired. If not, the processor 12 proceeds to step 210 which will be described below. If so, the process 200 continues to step 204 at which digital content is loaded into memory 14 under the control of programming executed by the processor 12. At step 206, a user may manually set the location of the video camera 30 as described above or choose programming to set a mode of camera operation, e.g. pan versus fixed. At step 208, the administrator may set camera settings, such as to record continuously, periodically, or, in some embodiments, upon detection of motion or operation of the touch screen. Following setup, the process 200 proceeds to step 210.

At step 210, the processor 12 determines if the camera 30 should be activated and, if not, returns control to step 202. If, however, it is determined at step 210 to begin recording, the process 200 proceeds to step 212 at which the display device is activated to display digital content. Then, the process 200 proceeds to step 214 at which the video camera 30 is activated. Video is recorded and transferred to memory 14 at step 216. Data transmission may also be made to a remote location through wireless transmission as described previously.

The steps of actively displaying content and recording security video are repeated until either a user interrupts the process by operating the touch screen display device 20 or until an administrator interrupts the process, such as to replay recorded video. More particularly, the processor 12 determines at step 218 if a user has interrupted the process flow, such as by engaging with the touch screen display device. If the processor 12 detects a touch screen input, then the process 200 proceeds to step 220 at which the active content displayed on the display device 20 is changed according to programming instructions. In other words, the processor 12 causes the display device 20 to respond appropriately to an interactive input by a user. Following said update, the process 200 returns to step 218 where is again determined if another user input has been submitted. If, however, no user interrupt is detected, then the process 200 proceeds to step 222.

At step 222, the process 200 determines if an administrator has interrupted the process 200, such as by a predetermined operation of the input buttons 19. More particularly, an administrator is able to interrupt the process at any time so as to review recorded video. If no interrupt is found, then the processor 12 returns control to step 216 such that the active display and security recording may continue. In the case of an administrative interrupt, however, control is passed to step 224 where the processor 12 determines if the administrator desires to play back recorded video. If the processor determines playback is desired, then the process 200 continues to step 236 where the display device 20 is actuated to display recorded video. Otherwise, the process 200 continues to step 228. At step 228, the processor determines if the administrator desires to return to setup and, if so, passes control to step 202. It is understood that returning to setup enables an administrator the opportunity to upload additional or new digital content. In summary, therefore, an administrator may initiate an interrupt in order to playback recorded video data or to upload new digital content to the system 10. Otherwise, control is returned to step 216 and the procedure of recording and transmitting video is resumed.

In use, the security and marketing system 10 may be installed in any location where security monitoring is desired, such as inside an elevator, a business lobby, a retail sales floor, or the like. The system 10 may be installed using the mounting members 25a as described above or simply supported atop a countertop or table. Digital content may be uploaded to memory and initiated to be displayed by the display device 20. The video camera 30 may also be initiated to record an area forward of the display device 20. The video camera 30 may be positioned behind a view portal such that the camera 30 is not seen by persons in front of the display device 20 but that allows the camera 30 to have a clear view of the area in front of the display device 20. The display device 20 may be an interactive touch screen device that enables persons being video recorded to actually interact with the display device.

It is understood that while certain forms of this invention have been illustrated and described, it is not limited thereto except insofar as such limitations are included in the following claims and allowable functional equivalents thereof.

1. A security and marketing system, comprising:
a processor configured to execute programming instructions;
a memory in data communication with said processor, said memory configured to store said programming instructions for execution by said processor and digital content;
a display device in data communication with said processor and configured to display said digital content according to said programming instructions, said display device including a generally transparent view portal; and
a video camera rearwardly adjacent said display device and adjacent said view portal, said video camera being directed to record data from an area forward of said display device.

2. The security and marketing system as in claim 1, wherein said video camera is electrically connected to said memory for storing recorded data.

3. The security and marketing system as in claim 1, wherein said display device includes:
a display device framework;
a display screen situated in said framework.

4. The security and marketing system as in claim 3, wherein said display device framework defines said view portal.

5. The security and marketing system as in claim 4, wherein said view portal is a tinted window.

6. The security and marketing system as in claim 3, wherein said display screen is substantially transparent when said digital content is not displayed thereon.

7. The security and marketing system as in claim 6, wherein said transparent display screen is said view portal.

8. The security and marketing system as in claim 7, wherein:
said display device is a touch screen configured to receive touch screen data input;
programming when executed by said processor causes said digital content to be changed according to said touch screen data input.

9. The security and marketing system as in claim 5, wherein:
said display device is a touch screen configured to receive touch screen data input;
programming when executed by said processor causes said digital content to be changed according to said touch screen data input.

10. The security and marketing system as in claim 1, wherein:
said display device is a touch screen configured to receive touch screen data input;
programming when executed by said processor causes said digital content to be changed according to said touch screen data input.

11. The security and marketing system as in claim 1, wherein said display device includes at least one mounting member configured to mount said display device to a wall, said at least one mounting member defining said view portal.

12. The security and marketing system as in claim 1, further comprising a USB port in data communication with said processor configured to communicate digital content to said memory.

13. The security and marketing system as in claim 5, wherein said video camera is removably coupled to a back of said display device framework adjacent said view portal.

14. The security and marketing system as in claim 1, further comprising:
a transmitter in data communication with said processor;
programming that when executed by said processor causes said transmitter to transmit said recorded data;
a receiver in data communication with said processor;
programming that when executed by said processor that causes said receiver to receive additional digital content for storage in said memory.

15. The security and marketing system as in claim 1, further comprising:
programming that when executed by said processor causes said video camera to record data from an area forward of said display device; and
programming that when executed by said processor causes said recorded data to be stored in memory.

16. The security and marketing system as in claim 15, further comprising:
programming that when executed by said processor causes said video camera to stop recording upon receiving an administrator interrupt input indicative of a new content update; and
programming that when executed by said processor causes said video camera to stop recording upon receiving an administrator interrupt input indicative of a request to playback recorded data.

17. The security and marketing system as in claim 8, further comprising:
programming that when executed by said processor causes said video camera to record data from an area forward of said display device;
programming that when executed by said processor causes said recorded data to be stored in memory;
programming that when executed by said processor causes said video camera to stop recording upon receiving an administrator interrupt input indicative of a new content update; and
programming that when executed by said processor causes said video camera to stop recording upon receiving an administrator interrupt input indicative of a request to playback recorded data.
